(19) United States
(12) Patent Application Publication
(10) Pub. No.: US 2003/0090529 A1
(43) Pub. Date: May 15, 2003

(54) Method for constituting multifunctional keys

(76) Inventor: John Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/987,215

(22) Filed: Nov. 14, 2001

(51) Int. Cl. G06F 3/023

(52) U.S. Cl. 345/843

(57) ABSTRACT

The present invention relates to a method for constituting multifunctional keys installed in keyboards of electronic devices from which the signals for opening a multi-option function-selection pull-down manual on the screen of a monitor or any display panels can be issued. When the multifunctional key or an activation unit is presses down, the microprocessor of the keyboard will send out a signal to the host device. The host device then opens a corresponding multi-option function-selection pull-down manual and the multi-option function-selection pull-down manual is then displayed on the screen for the selecting of the user, so that the host device executes the selected function.

### FIELD OF THE INVENTION

The present invention relates to a method for constituting multifunctional keys installed in keyboards of electronic devices from which the signals for opening a multi-option manual on the monitor or screen can be initiated.

### BACKGROUND OF THE INVENTION

Keyboards, keypads, or similar button modules are often used in electronic devices, such as personal computers, industrial computers, programmable logic controllers, cash machines, credit card machines, etc., as an interface of sending action commands by the user. However, the operation functions of keyboards or button modules of electronic devices, in the states of prior arts, are already fixed after they are manufactured. The functions and operation details of a conventional keyboard is predetermined and fixed before it is on the market, and it fails to provides capabilities for the user to define functions of specific keys by themselves. Some conventional keyboards offer a number of key combinations in which these multiple keys need to be pressed down at the same time so as to execute specific actions. However, it is very troublesome and inconvenient for the user to memorize a list of key combinations and their corresponding functions.

In order to offer more function keys and hot keys on the conventional keyboards, the manufacturers have to redesign or expand the circuits of the keyboard matrix, which will consequently increase the cost of designing and manufacturing a keyboard. Nevertheless, the expansion of the function keys and hot keys is easily limited by the wiring space and the number of function keys and hot keys that can be inserted to the keyboard is always less than that is desired.

### SUMMARY OF THE INVENTION

It is therefore an object of the present invention to provide a method for constituting multifunctional keys by which a multi-option pull-down manual for key functions can be easily created on the screen so that users can conveniently select desired key functions.

It is another object of the present invention to provide a method for constituting multifunctional keys by which selection of keys for specific functions can be operated in an easy on-screen selection manner without the need of memorizing.

It is a further object of the present invention to provide a method for constituting multifunctional keys by which the keyboards can be used to operate multifunctional key selections without the need of altering the keyboard circuits so that the development cost of the circuit hardware can be reduced.

To achieve the above objects, the present invention provides at least one multifunctional key or button installed on the keyboard from which the command of opening the multi-option pull-down manual for key selection on the screen is issued. The present invention also provides a pre-programmed multi-option pull-down manual for key selection in the memory (ROM) of the electronic devices. Therefore, when the command of opening such a multi-option pull-down manual for key selection from a multifunctional key is detected by the microprocessor of the keyboard, the microprocessor will send a signal to the electronic host device and the electronic host device will then display the multi-option pull-down manual for key selection on the screen for the user to operate function selections.

Other objects, advantages and constructions of the present invention will become more apparent from the following description and the drawings.

### BRIEF DISCRIPTION OF THE DRAWINGS

The present invention will be apparent to those skilled in the art by reading the following description of preferred embodiments thereof, with reference to the accompanying drawings, in which:

FIG. 1 is a block diagram showing the hardware system of the present invention.

FIG. 2 is a flowchart showing the detailed operation of the present invention.

### DETAILED DESCRIPTION OF THE PREFERRED EMBODIMENT

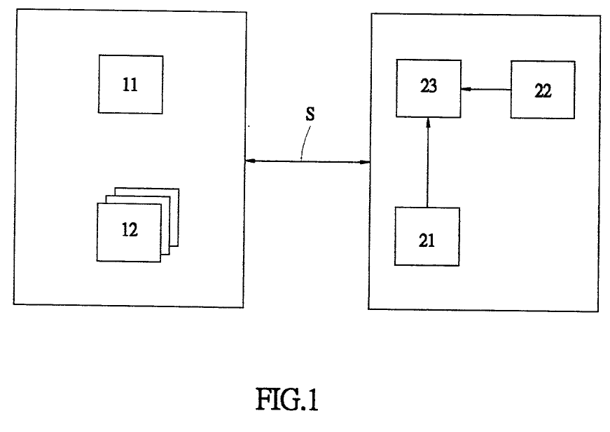

Referring to FIG. 1, the hardware system of the present invention comprises an electronic host device 10 and a keyboard 20. The electronic host device 10 is referred to as an electronic equipment such as personal computer, industrial computer, programmable logic controller, cash machine, credit card machine, etc., in which a keyboard 20, a keypad, or a button module is required to issue control commands. On the keyboard 20, there exists at least one key 21 or activation unit 22 installed on an arbitrary location of the keyboard for users to open the on-screen multi-option pull-down manual. The activation unit can be a photo-sensing device, touch pad, card reading machine, or other devices initiated by any contact elements.

When the above-mentioned key 21 or activation unit 22 is pressed or touched, the microprocessor 23 of the keyboard 20 will send an action signal S to the electronic host device 10. The memory 11 or ROM of the electronic host device 10 stores a number of pre-programmed multi-option pull-down manuals for function selections 12, each of which corresponds to one of the keys 21 and activation units 22. As the action signal S is received by the electronic host device 10, the electronic host device 10 will respond and display a corresponding multi-option function-selection pull-down manual 12 on the screen. The user can use a mouse or photo-pointer to conduct the function selection.

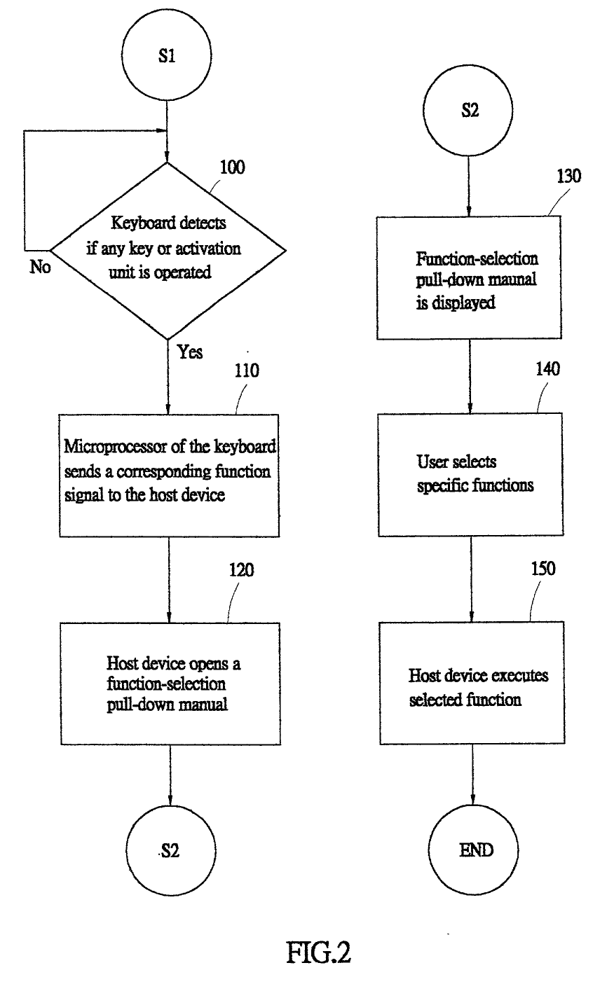

Referring to FIG. 2, the operation procedure of the present invention can be defined as follows:

(100) The keyboard continues to detect if any key 21 or activation unit 22 is pressed or enacted. If true, proceed to step 110;

(110) The microprocessor 23 of the keyboard 20 Will then send a corresponding function signal S to the electronic host device 10;

(120) The electronic host device 10 will then open a corresponding multi-option function-selection pull-down manual by running an application software or window program according to the content of the signal S;

(130) The multi-option function-selection pull-down manual 12 is then displayed on the screen of a monitor or display mean of the electronic host device 10;

(140) The user then selects specific functions on the multi-option function-selection pull-down manual 12 by using a mouse or a photo-pen; and

(150) The electronic host device 10 executes the above-mentioned functions through embedded application software or programs.

By using the concepts and ideas shown in FIGS. 1 and 2, an electronic host device 10 can provide an easy multiple function selection approach through the multifunctional keys 21 or activation units 22 on the keyboard 20, so that users of personal computers, industrial computers, cash machines, credit card machines can easily select desired functions by pressing or touch the multifunctional keys 21 or activation unit on the keyboard 22, without the need of memorizing related functions for each of the multifunctional keys 21.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method for constituting multifunctional keys comprising a host device and a keyboard, a memory of the host device storing a number of multi-option function-selection pull-down manual, and at least one activation unit being installed on the keyboard so that the multi-option function-selection pull-down manual can be displayed on the screen by pressing or touching the activation unit, the operation procedure of the method comprising the following steps:
(a) The keyboard detects if any activation unit is pressed;
(b) The microprocessor of the keyboard then sends a corresponding function signal to the host device;
(c) The host device then opens a corresponding multi-option function-selection pull-down manual;
(d) The multi-option function-selection pull-down manual is then displayed on the screen;
(e) Users then select specific functions; and
(f) The host device executes the selected function.
